(19) United States
(12) Patent Application Publication
(10) Pub. No.: US 2002/0117512 A1
(43) Pub. Date: Aug. 29, 2002

(54) Photoprocessing method and apparatus

(75) Inventors: Anthony Earle, Harrow Weald (GB); Nigel R. Wildman, Watford Hertfordshire (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/014,687

(22) Filed: Dec. 11, 2001

(30) Foreign Application Priority Data
Dec. 21, 2000 (GB) 0031178.7

(51) Int. Cl. B67D 5/00

(52) U.S. Cl. 222/82; 222/83; 222/390; 222/391; 222/333

(57) ABSTRACT

Processing solution is delivered to a processing apparatus by means of a syringe type delivery system.. The container in which the solution is stored acts both as the storage container and as part of the metering system for delivering an accurate volume of solution.

### FIELD OF THE INVENTION

This invention relates to the photo-processing industry. In particular it relates to the delivery of processing solutions to a processor.

### BACKGROUND OF THE INVENTION

Containers in the form of cartridges are used to supply ready to use processing solutions to photographic processing apparatus. These containers are designed to be easily and quickly coupled to the apparatus. With respect to both kiosk and highly dispersed processing it is of interest to be able to supply the customer with easily replaceable chemical concentrate cartridges that are apparently dry, i.e. there is no contact with the solution itself It is also desirable to be able to deliver the concentrates accurately from the said cartridges into the processing apparatus. This invention combines these two criteria to provide a method that achieves both requirements in a robust cost-effective way.

Commonly mastics and sealant are available from DIY stores packaged in a large syringe type canister. Normally the syringe end is cut and the piston depressed with a “gun” to squeeze the sealant from the syringe. The contents of the syringe are normally of high viscosity, being paste or gel or Acrylic based. For example, Alpha Metals, a manufacturer, packs “Fernox”™, a central heating corrosion inhibitor gel into similar containers. They use a metal foil to seal the plunger end. As the packaging is made from high-density polyethylene and the plunger from low-density polyethylene the cartridge is easily recycled when empty.

It is an aim of the invention to provide a low cost accurate method of delivering processing chemistry to the customer and into the machine. It is an aim to provide a syringe delivery system for low viscosity fluids in which there is substantially no leakage and in which the containers for the processing solutions are recyclable. It has been have found by experimentation that the same container as described above can hold a low viscosity liquid without spillage even when the plunger is activated. This is due to the integrity of the seal and the hydrophobicity of the plastic material.

### SUMMARY OF THE INVENTION

According to the present invention there is provided a method of delivering processing solution to a processing apparatus wherein the solution is supplied in a storage container, the container forming part of a metering system.

The invention further provides a delivery unit for supplying processing solution to a processing apparatus, the unit comprising a storage container having a nozzle at one end thereof and incorporating a piston therein, and means for activating the piston such that a fixed amount of solution is delivered out of the container via the nozzle each time the piston is activated.

It has been found that solution can be delivered with remarkable accuracy by means of a simple, low cost yet effective mechanism described below.

Preferably a plastic seal is provided behind the piston.

The invention provides for the solutions used in a photoprocessing apparatus to be housed in an air tight, leak proof, robust, “apparently dry” container. This container is also part of the delivery mechanism. As the container is air-tight there is no solution movement within the container. This is particularly advantageous since the container therefore acts as a solid component during transport, installation and operation. It is not flexible and therefore does not require any external packaging for protection.

The invention avoids the need to supply the processing chemistry in separate containers which then require use of accurate pumping equipment for delivery.

The mechanism of the piston allows highly accurate delivery of the solutions at low cost.

The container size and fill volume can be easily adjusted to suit the solution to be housed. The volumes may be such that all containers empty at one time or at different times.

The containers are fully recyclable.

The invention may be used in all processes and at all process stages.

Use of a separate plastic seal ensures a “dry” system.

It would be advantageous to use a plastic seal (as is used over Kodak™ SM™ chemical packaging couplings) to ensure no chemical leak and to aid recycling of the container.

A conventional inexpensive “off the shelf” dispensing gun can be used to provide the dispensing apparatus.

The invention is particularly useful for single part chemistry, e.g. Kodak Ektacolor Prime SP™.

### BRIEF DESCRIPTION OF THE DRAWINGS

The invention will now be described, by way of example, with reference to the accompanying drawings, in which:

FIG. 1 is a schematic side view of a container suitable for use with the invention;

FIGS. 2 and 3 are schematic views of such a container with alternative ends to the nozzle;

FIG. 4 is a schematic side view of a delivery unit in accordance with the invention;

FIG. 5 shows the same unit once it has been emptied;

FIG. 6 is a schematic view showing the operation cycle of the cam;

FIGS. 7A and 7B illustrate two methods of changing the stroke of the piston within the container;

FIG. 8 illustrates a further container suitable for use with the invention;

FIG. 9 illustrates a method of activating the piston within the container; and

FIG. 10 illustrates a further method of activating the piston within the container.

### DETAILED DESCRIPTION OF THE INVENTION

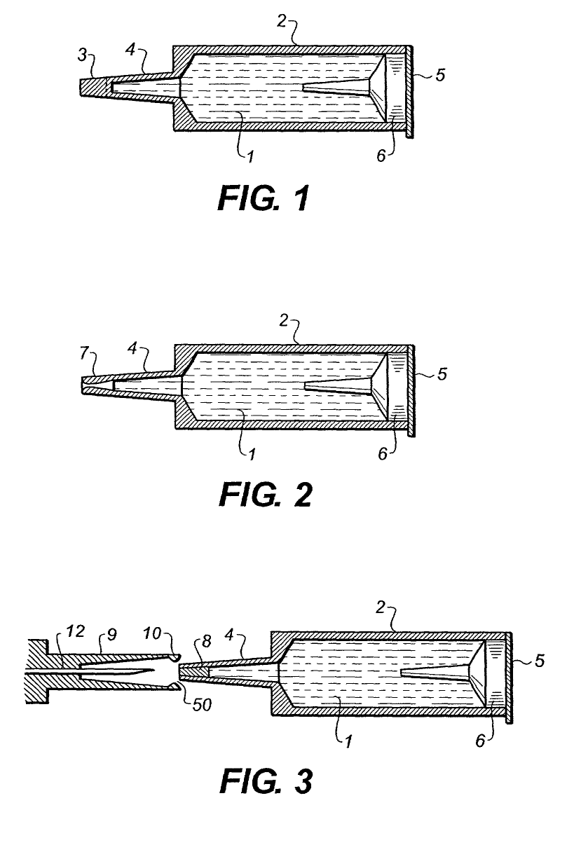

FIG. 1 shows the general arrangement of the photographic chemical delivery and supply container.

A cylinder 2 houses the photographic solution 1. The cylinder 2 has a nozzle 4 at one end. This nozzle is sealed with a break off tip 3 at the end thereof. The cylinder 2 is also provided with a movable piston 6. The front end of the piston has a protrusion or shaped member sized to fit into the nozzle 4 of the cylinder 2. A removable or pierceable seal 5 is provided behind the piston 6. The seal 5 is provided in case some photographic solution seeps past the piston 6 during storage before use.

In storage the container is full of photographic solution 1 and the piston 6 is at the opposite end of the cylinder from the nozzle 4. When the solution is required to be delivered to the processing apparatus the piston 6 is operated to push the solution out of the nozzle 4. FIGS. 2 and 3 illustrate two alternative ends for the nozzle 4. It will be understood by those skilled in the art that the invention is not limited to the two embodiments illustrated.

FIG. 2 shows a non-return valve 7 fitted to the end of the nozzle 4. This valve 7 will lift to pass solution only when the piston 6 raises the pressure in the cylinder 2 during a solution delivery cycle.

FIG. 3 shows a plug 8 fitted into the end of the nozzle 4.

In the operation of the embodiment shown in FIG. 3 the cylinder 2 full of solution 1 is pushed into the opening 50 of the processing apparatus. This opening includes a conical rubber seal 9 which seals against the nozzle 4 with the aid of a moulded feature 10. A hollow probe 12 then pierces the plug 8 and enters the cylinder 2 where the solution is held. The piston 6 then pushes out the solution through the probe 12.

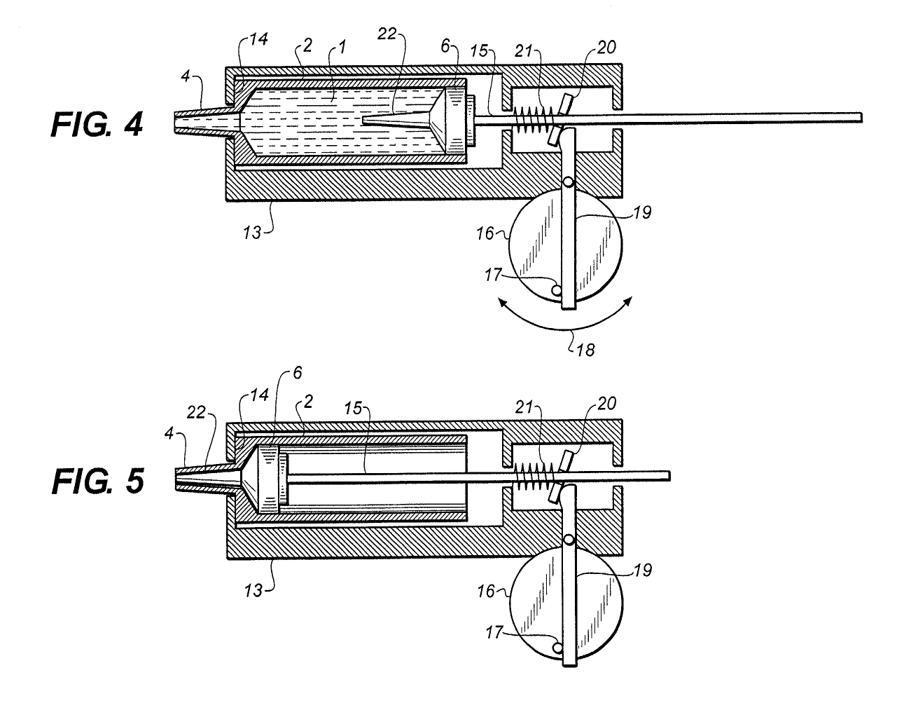

FIG. 4 shows the cylinder 2 fixed firmly within a cam operated delivery unit 13. The delivery unit has two chambers, one housing the cylinder 2 and the second housing activation means for the piston 6. The chambers are connected via a bore to allow passage of a push rod plunger 15. A front stop plate 14 is located at the front of the delivery unit 13. The front of the cylinder 2 is pushed up to the front stop plate 14 by means of the push rod plunger 15. The nozzle passes through a corresponding opening in the front wall of the first chamber. A cam-plate 16, located external to the delivery unit 13, has an operating pin 17 attached thereon. The operating pin 17 bears against one end of a lever 19. The other end of the lever 19 bears against a one way clutch plate 20. The clutch plate 20 is movably located on the push rod plunger 15 and is biased by spring 21. The spring is retained between the clutch plate 20 and the front wall of the second chamber.

In use, as the cam-plate 16 rotates the operating pin 17 moves with it. The movement of the pin 17 pushes the operating lever 19 back and forth in the direction of the arrow shown in FIG. 4. The lever 19 bears against the clutch plate 20 causing it to tip and grip the push-rod plunger 15. This causes the plunger 15 to advance. As it advances it pushes piston 6 forward and delivers a shot of solution. The cam-plate 16 and pin 17 continue to rotate, releasing the clutch plate 20 from the push-rod where upon spring 21 pushes it back to its starting position.

Since the cam 16 moves a predetermined distance and this in turn moves the piston 6 a fixed amount of solution is delivered at each stroke. The cam is operated by an electric motor, not shown.

FIG. 5 illustrates how the shape of the piston 6 ensures that all of the solution 1 is delivered.

The front end of the piston 6 has a shaped member or protrusion 22. As explained above, the protrusion 22 is designed to fit exactly into the delivery nozzle 4 so that when the piston has swept the full length of the cylinder 2 the shaped protrusion has also displaced any solution that might remain in the nozzle.

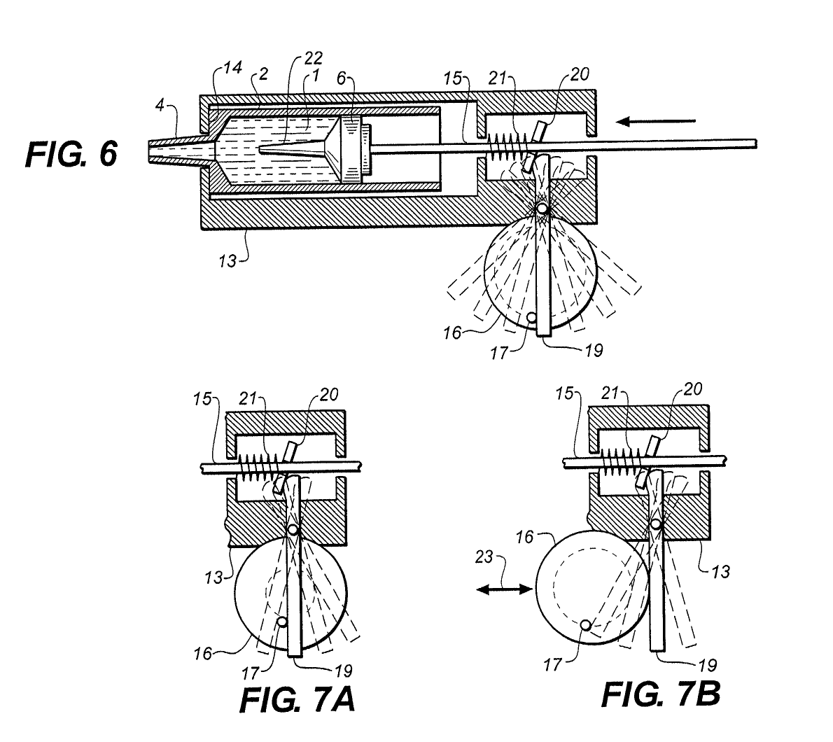

FIG. 6 illustrates the motion of the cam-plate pin 17 and lever 19 as it completes one cycle.

The amount of solution dispensed from the cylinder can be very accurately varied and controlled by simply changing the stroke of the clutch and hence the displacement by the piston. FIG. 7 shows two method of doing this. FIG. 7A illustrates how the stroke is changed by moving the position of the pin 17 on the cam-plate 16. FIG. 7B illustrates how the stroke is changed by moving the whole cam-plate assembly back or forth, as indicated by the arrow, with respect to the lever 19.

As the piston only advances one way no air gets into the container. There is therefore no solution movement within the container once it is packed. It therefore acts as a “solid” component, having the aforementioned advantages.

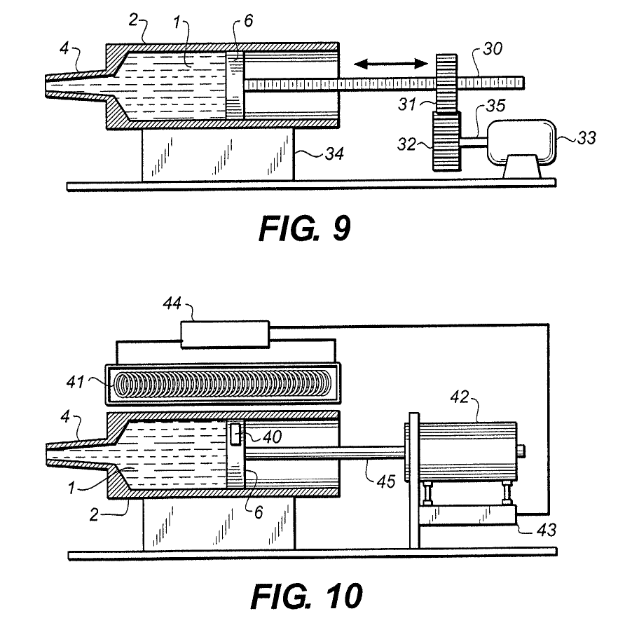

Another method of actuating the piston would be to use a screw thread mechanism. This is illustrated in FIG. 9. A screwthread 30 is attached to the rear of the movable piston 6. The screwthread 30 passes through a threaded central hole in gear 31. Gear 31 is in drive connection with the gear 32. Gear 32 is connected via drive shaft 35 to motor 33. The cylinder 2 is supported by support member 34.

When solution is to be dispensed from the cylinder 2 the motor 33 is activated. The motor 33 drives gear 32 which in turn drives gear 31. As the gear 31 has a threaded central hole the screwthread 30 is moved linearly by the movement of the gear 31. The screwthread is not rotated by movement of the gear 31. As the screwthread moves linearly it pushes the piston 6 towards the nozzle of the cylinder, thus dispensing the solution. This mechanism can be continuously variable by altering the number of rotations of the threaded screw. Accurate and variable control of solution delivery is hence obtained.

A further method of actuating the piston is illustrated in FIG. 10. In this embodiment a magnet 40 is provided on the piston 6. A pneumatic or hydraulic cylinder 42 is in connection with the rear of the piston 6 via a push rod 45. The cylinder 42 is provided with control means 43. An electromagnetic sensing coil 41 is located adjacent the cylinder 2. Sensing means 44 is in electrical connection with the coil 41.

When solution is to be dispensed from the cylinder 2 the pneumatic or hydraulic cylinder 42 is activated. The piston 6 moves forward, pushing solution out of the nozzle. As the piston moves magnet 40 moves with it. The movement of the magnet 40 cause a change in the electromagnetic field of the sensing coil 41. This change is detected by the sensing means 44. When the piston has moved a predetermined distance, and thus dispensed a predetermined volume of solution, a signal is sent from the sensing means 44 to the control means 43 causing the cylinder to stop moving the piston rod 45.

Although a pneumatic/hydraulic cylinder has been illustrated it will be understood that any linear drive mechanism could be used.

In both FIGS. 9 and 10 the piston 6 is shown without the nozzle shaped front for simplicity.

The above are examples of actuating the piston. It will be understood that any suitable method may be used.

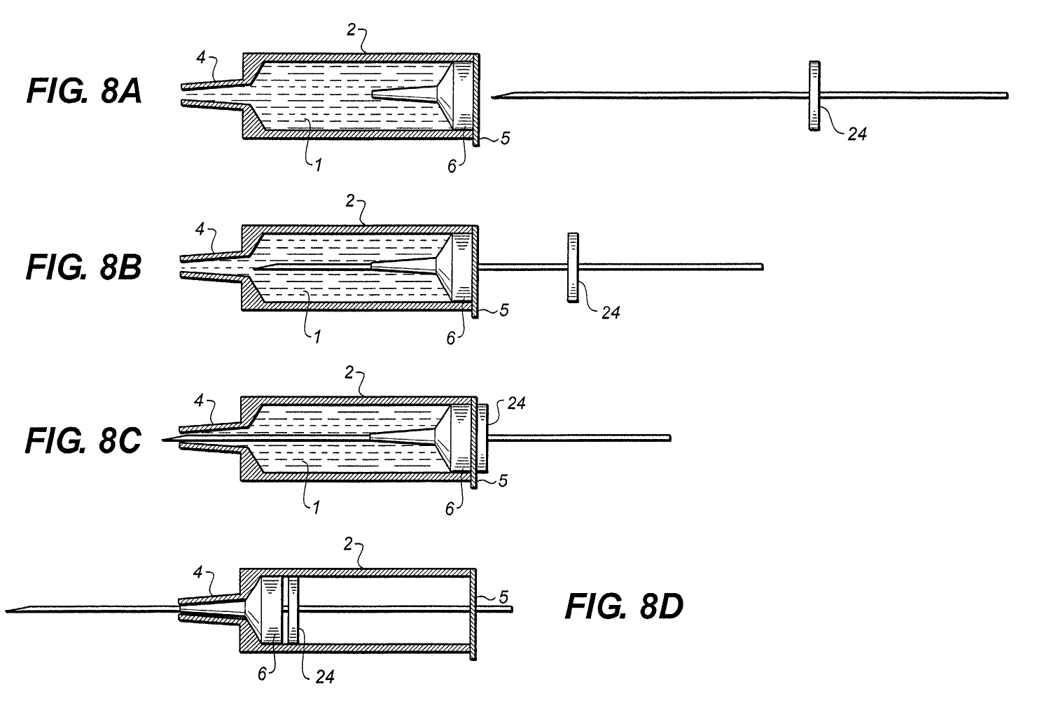

In all of the examples described above the sealing membrane 5 has been removed prior to use. In the embodiment shown in FIG. 8 this membrane 5 can be left in place as the push rod is provided with a spiked cutter 24. The spiked cutter opens a hole in the membrane, pierces the piston and punctures the outlet end of the cylinder before the plunger engages with the piston.

### EXAMPLE

In Run 1 a 1 liter cylinder supplied by Fisbach, a manufacturer, was fitted to a delivery gun supplied by Kennet, a manufacturer, which was actuated via a cam to deliver a set movement of the gun's trigger. After each rotation of the cam the mass of water delivered from the cylinder into a container on a balance was measured. After a predetermined number of strokes the mean volume (ml) delivered, the standard deviation, the maximum and the minimum volumes (ml) were calculated. The experiment was repeated in Run 2 with a reduced trigger movement. The data below show the results obtained were quite accurate considering the low cost and complexity of the delivery gun.

Run 1

| | |
|---|---|
| 1 | 16.27 |
| 2 | 16.16 |
| 3 | 16.28 |
| 4 | 16.37 |
| 5 | 16.43 |
| 6 | 16.45 |
| 7 | 16.42 |
| 8 | 16.29 |
| 9 | 16.21 |
| 10 | 16.22 |
| 11 | 16.24 |
| 12 | 16.2 |
| 13 | 16.22 |
| 14 | 16.18 |
| 15 | 16.12 |
| 16 | 16.19 |
| 17 | 16.27 |
| 18 | 16.14 |

| | |
|---|---|
| Mean | 16.26 |
| Standard deviation | 0.099 |
| Max | 16.45 |
| Min | 16.12 |

Run 2

| | |
|---|---|
| 1 | 5.501 |
| 2 | 5.466 |
| 3 | 5.513 |
| 4 | 5.492 |
| 5 | 5.48 |
| 6 | 5.514 |
| 7 | 5.414 |
| 8 | 5.561 |
| 9 | 5.49 |
| 10 | 5.51 |
| 11 | 5.585 |
| 12 | 5.509 |
| 13 | 5.496 |
| 14 | 5.546 |
| 15 | 5.5 |
| 16 | 5.47 |
| 17 | 5.61 |
| 18 | 5.5 |
| 19 | 5.6 |
| 20 | 5.52 |
| 21 | 5.48 |
| 22 | 5.51 |
| 23 | 5.46 |
| 24 | 5.46 |
| 25 | 5.56 |

| | |
|---|---|
| Mean | 5.509 |
| Standard deviation | 0.046 |
| Max | 5.61 |
| Min | 5.414 |

The interface between the processing equipment and the syringe could either be via moulded threaded part that mates with a corresponding fitting on the machine or by a system that punctures the moulded seal as the unit is screwed into a housing.

It is possible that the syringes that contain different photochemicals have different pin registrations, to ensure that the wrong solution is not fitted to the chemical delivery system. This would be deleterious to the process. Other means of ensuring that the correct solutions are supplied to the system is to have different threads or other moulded parts of the containers for different solutions. It is apparent that any photographically useful chemical could be packed in this way and syringes of various volumes are available. Air is excluded from the packaging and photochemicals should display good storage. The delivery unit is apparently dry. As no air is included it will not feel like solution is contained within.

The invention has been described in detail with reference to preferred embodiments thereof. It will be understood by those skilled in the art that variations and modifications can be effected within the scope of the invention.

What is claimed is:

1. A method of delivering processing solution to a processing apparatus wherein the solution is supplied in a storage container, the container forming part of a metering system.

2. A method as claimed in claim 1 wherein the metering system is a positive displacement system.

3. A method as claimed in claim 2 wherein the displacement is caused by movement of a cam.

4. A method as claimed in claim 2 wherein the displacement is caused by a screwthreaded member.

5. A method as claimed in claim 2 wherein the displacement is caused by linear motion delivery.

6. A method as claimed in claim 1 whereby the container has no voids or airspace within, thus ensuring no movement of solution within the container and ensuring accurate delivery throughout operation.

7. A method as claimed in claim 1 wherein the container is punctured as it is fitted onto the processing apparatus.

8. A method as claimed in claim 1 wherein the container is punctured prior to being fitted onto the processing apparatus.

9. A method as claimed in claim 2 wherein the container is fully emptied by the positive displacement system.

10. A delivery unit for supplying low viscosity processing solution to a processing apparatus, the unit comprising a storage container having a nozzle at one end thereof and incorporating a piston therein, and means for activating the piston such that a fixed amount of solution is delivered out of the container via the nozzle each time the piston is activated.

11. A delivery unit as claimed in claim 10 wherein a plastic seal is provided behind the piston.

12. A delivery unit as claimed in claim 10 wherein a non return valve is fitted to the end of the nozzle.

13. A delivery unit as claimed in claim 10 wherein the front end of the piston is shaped to fit exactly into the nozzle.

14. A delivery unit as claimed in claim 10 wherein the activation means comprises a rod for pushing the piston, the rod being in connection with a clutch plate activated by a cam.

15. A delivery unit as claimed in claim 14 wherein the rod is provided with spiked cutting means.

16. A delivery unit as claimed in claim 14 wherein the amount of solution delivered can be varied by changing the stroke of the clutch and thereby the displacement of the piston.

17. A delivery unit as claimed in claim 10 wherein the activation means comprises a screw thread mechanism.

18. A delivery unit as claimed in claim 17 wherein the amount of solution delivered can be varied by altering the number of rotations on the screw thread.

19. A delivery unit as claimed in claim 10 wherein the unit is provided with identification means to identify the particular solution contained within the container.

20. A delivery unit as claimed in claim 10 wherein the container is manufactured from recyclable plastics material.

21. A delivery system for delivering processing solutions to a processing apparatus including a unit as claimed in claim 10.
